(19) United States
(12) Patent Application Publication
(10) Pub. No.: US 2004/0145475 A1
(43) Pub. Date: Jul. 29, 2004

(54) School security method and system for implementing same

(76) Inventor: Norman Greenberger, Norwalk, CT (US)

Correspondence Address: ANTHONY H. HANDAL, KIRKPATRICK & LOCKHART, LLP, 599 LEXINGTON AVENUE, 31ST FLOOR, NEW YORK, NY, 10022-6030, US

(21) Appl. No.: 10/703,120

(22) Filed: Nov. 6, 2003

Related U.S. Application Data
(60) Provisional application No. 60/424,239, filed on Nov. 6, 2002.

(51) Int. Cl. G08B 13/14

(52) U.S. Cl. 340/572.1; 340/573.1; 340/825.49

(57) ABSTRACT

In accordance with the invention, a student security system for securing a school comprises a facility with a plurality of portals to be secured. A plurality of identification tags are each associated with a respective student and adapted to be carried by a student. Each identification tag incorporates a respective associated student code. A computing device has access to sets of associated information. Each set is associated with a respective one of the associated student codes. The associated information is particular to the respective associated student. A portal reader is associated with the portal. The portal reader is capable, within a range of distance, of reading the student code associated with the identification tags to determine presence information. A transportation vehicle has a vehicle portal. A vehicle reader is associated with the vehicle portal, the vehicle reader being capable of reading the student code associated with the identification tags to determine pickup information. A communications link connects the vehicle readers and the computing device. A communications link connects the portal readers and the computing device. A database contains student specific expected pickup and presence information. An algorithm resident in the computing device derives behavioral information from the presence and pickup information, and compares the presence and pickup information to expected pickup and presence information to determine deviations from expected behavioral information. Information gathered by the system is used to detect various situations, and to implement parental directives in diet, and related areas. In addition, the system allows minimization of exposure to danger in the case of children walking to school.

### CROSS REFERENCE TO RELATED APPLICATION

This application claims the benefit of U.S. Provisional Patent Application No. 60/424,239 filed Nov. 6, 2002, confirmation number 7766, the disclosure of which is hereby incorporated herein by reference thereto.

### TECHNICAL FIELD

The present invention relates to a security system particularly suited for implementation in educational systems.

### BACKGROUND OF THE INVENTION

Life, particularly in large cities, while it presents students with great opportunities, also presents a collection of serious dangers from persons who prey upon student populations. Given the limited numbers of people who are employed to monitor the activities of students during the school day and the impossibility of monitoring student situations on school grounds outside class, as well as student situations off school grounds, for example in the community, at stores, and in the process of transit to school, comprehensive protection of student populations is not being remotely achieved at this time.

For example, when moving from home to a bus pickup point, children are likely to be subject to dangerous conditions. Possibilities include violence, drug sales, robbery and so forth. Parental escort is often not possible because bus schedules may not be kept well enough for a parent to meet other obligations, for example, at a job.

While perhaps not a primary point of concern due to the presence of a bus driver, dangerous incidents could occur during transit. It is also possible that the driver may not be in a condition suitable to drive a bus. For example, a heightened emotional state, intoxication, or general recklessness may pose dangers during transit.

At school, numerous dangers are presented such as violence, student to student robbery and the presence of unauthorized individuals at the educational facility.

### SUMMARY OF THE INVENTION

In addition to the above problems, numerous, perhaps less dramatic, but nevertheless serious problems are presented in the educational environment. For example, once outside the sphere of their parent's influence, children at school are liable to a wide diversity of behavior not consistent with parental guidance. For example, students are likely to depart from dietary guidelines implemented by their parents. While, to some extent, the school can provide some protection in this area under current procedures, for example by limiting the time during which certain foods of a less desirable nature are available and by limiting the nature of food products available at the school, community standards may differ from parental standards. For example, certain parents may wish their children never to consume high refined sugar and desserts, such as pizza, cakes, gelatin and soda. Other parents may wish to tolerate limited consumption of these foods, for example, at the rate of one for each meal, or perhaps less frequently. It is likely that school cafeterias will include all of these items.

More subtle problems may exist in the area of food consumption. For example, some parents may wish their children to have a balanced diet in accordance with conventional formulas. Other parents may subscribe to the belief that the newer government recommended diet involving sparing use of fats, moderate use of proteins, and substantial use of carbohydrates in the diet is preferable.

Obviously, for a school cafeteria to cater to all parental preferences involves a wide variety of product availability and reliance upon students conforming to parental guidelines. Obviously, in many cases, even general adherence to such guidelines is unlikely. Moreover, the use of cash for commodities not sold by the school is also possible, thus bringing in the possibility of drugs, gaming, and other unsavory activity.

Still other aspects of student behavior present potential problems. For example, if the student is spending too long a time in the bathroom, this may be evidence of smoking or drug use. If there are too many trips to the bathroom, this may indicate a health condition which requires inquiry. Unfortunately, however, teachers and other school personnel are incapable of any meaningful monitoring of such factors globally. In addition, they may be too distracted with primary tasks to detect the subtle signs that often are the only indications of potential problems which should be investigated.

In accordance with the invention, different levels of security may be provided. In accordance with the invention, a student security system for securing a school comprises a facility with a plurality of portals to be secured. A plurality of identification tags are each associated with a respective student and adapted to be carried by a student. Each identification tag incorporates a respective associated student code. A computing device has access to sets of associated information. Each set is associated with a respective one of the associated student codes. The associated information is particular to the respective associated student. A portal reader is associated with the portal. The portal reader is capable, within a range of distance, of reading the student code associated with the identification tags to determine presence information. A transportation vehicle has a vehicle portal. A vehicle reader is associated with the vehicle portal, the vehicle reader being capable of reading the student code associated with the identification tags to determine pickup information. A communications link connects the vehicle readers and the computing device. A communications link connects the portal readers and the computing device. A database contains student specific expected pickup and presence information. An algorithm resident in the computing device derives behavioral information from the presence and pickup information and compares the presence and pickup information to expected pickup and presence information to determine deviations from expected behavioral information.

The inventive system may be configured to be able to read a room of students at one time for attendance.

In accordance with the invention, the portal reader and the vehicle reader are capable of reading the student code incorporated in the tags while the tags are visible or not visible.

In accordance with the preferred embodiment, the system further comprises a plurality of staff identification tags, each associated with a respective school staff member and adapted to be carried by a school staff member, each identification tag incorporating a respective associated school staff member code, and wherein the algorithm generates school staff time records.

The inventive system may also be used to generate school student and school staff attendance records.

Warehouse inventory and changes in inventory may be tracked by the inventive system.

The inventive system may further be applied to a plurality of lend items, each of the lend items optionally comprising a visible bar code or a lend item identification tag incorporating a respective associated lend item code identifying its respective lend item. The portal reader associated with the portal is capable of reading the lend item codes associated with the lend item identification tags to determine lend item presence information and to generate a proposed lend description comprising a lend item identity or lend item identities. An algorithm, which is resident in the computing device, is structured to compare the lend item identity(s), a student code within the range of the reader and a list of approved lend item information to derive a signal indicating a decision of approval or disapproval with respect to removal of the lend item across the portal.

In accordance with another module of the invention, a geographic position sensing system is associated with the school bus or other transportation vehicle for generating a geographic information signal. A communications link connects the geographic position sensing system and the computing device. A database contains student specific expected pickup locations. An algorithm resident in the computing device derives geographical proximity to a pickup location for a respective student from the geographic position sensing system and compares the geographic information signal to a respective expected pickup location to determine an expected pickup time. A telecommunications channel connects the computing device and the custodial individuals for reporting pickup information to the custodial individuals.

More particularly, the geographic position sensing system associated with the transportation vehicle is a satellite based positioning system.

The database of student specific expected pickup locations may further comprise information indicating the time needed to transport the student to a respective associated pickup location, whereby the algorithm causes the computing device to transmit along the telecommunications channel to the custodial individuals expected pickup information. This telecommunications channel may be a public telephone system.

Alternately, the inventive system may employ a publicly accessible computer network, such as the Internet.

The inventive system also provides a tool for parental supervision by including a database of student specific sets of associated parental supervision information. Each of the sets of associated parental supervision information is associated with a respective one of the associated student codes and is particular to the respective associated student. A computing device has access to the sets of associated parental supervision information.

The system may be augmented by a point of sale device, comprising a device for inputting product identities for products to be purchased by a particular student to generate a proposed purchase description comprising a particular set comprising a product identity or a plurality of product identities, a point of sale reader capable of reading the student code associated with the identification tags to generate a particular student code associated with the particular student, and a communications link between the point of sale device and the computing device. An algorithm resident in the computing device is structured to compare the particular product identities and a set of parental supervision information associated with the particular student code and derive a signal indicating a decision of approval or disapproval with respect to the proposed purchase description. A telecommunications channel between the computing device and a source of funds.

Money may also be loaded onto the inventive card, so ala carte sales can be achieved, linked to parents checking, (easy pass) or by check or cash. The inventive system may also be configured to differentiate free, reduced meals and ala carte students to eliminate the stigma of being poor.

The products may include a bar code imprint or tag and a device for inputting product identities for products to be purchased by a particular student to generate a proposed purchase description comprising a particular set comprising a product identity or a plurality of product identities, as read by a bar code reader.

The inventive student security system may further comprise a communications link between a plurality of portal readers (positioned at various points throughout a school facility) and the computing device. A database of student specific expected presence information is used by an algorithm resident in the computing device for deriving behavioral information from the presence and pickup information, and comparing the presence and pickup information to expected pickup and presence information to determine deviations from expected behavioral information.

A plurality of staff identification tags, each associated with a respective school staff member and adapted to be carried by a school staff member each incorporate a respective associated school staff member code, and information from such tags may be used by the computer to generate school staff time records and school student attendance records.

The inventive system contemplates that the area readers are capable of reading the presence of tags within their range, and capable of comparing known student locations to typical safe situation location specifications and typical unsafe situation location specifications to determine the existence of an unsafe condition.

The system may further comprise a plurality of visitor identification tags, each associated with a respective school visitor and adapted to be carried by a school visitor, each identification tag incorporating a respective associated school visitor code, and wherein the algorithm resident in the computer compares known visitor staff and student locations to typical safe situation location specifications and typical unsafe situation location specifications to determine the existence of an unsafe condition.

### BRIEF DESCRIPTION OF THE DRAWINGS

Various aspects or features, some or all of which may be incorporated into a school security system constructed in accordance with the invention, will be understood from the description below with reference to the figures, in which:

FIG. 1 illustrates an implementation of the invention in schematic form; and

FIG. 2 is a block diagram of a control system useful for implementing the method of the present invention.

### DETAILED DESCRIPTION OF THE BEST MODE OF THE INVENTION

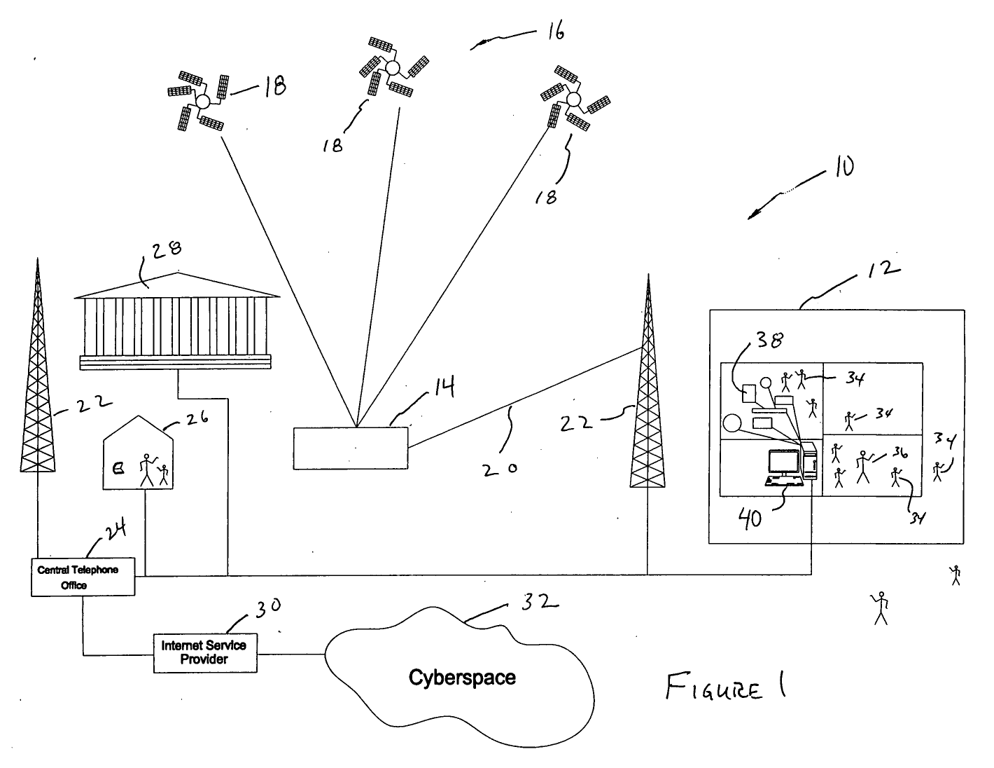

Referring to FIG. 1, an example of a school security system 10 constructed in accordance with the present invention is illustrated. System 10 includes a school facility 12 and a school bus 14. School bus 14 is locatable through the use of a global positioning system 16 comprised of a plurality of satellites 18. Satellites 18 transmit a signal which is detected by a GPS unit located on school bus 14. School facility 12 is connected to school bus 14 through the use of a wireless telephone link 20, which operates in conjunction with cellular towers 22. Cellular towers 22 are connected to the central telephone office 24. School facility 12 is also connected to central telephone office 24.

While alternative means of connection are also available, a plurality of student homes 26 are connected via central telephone office 24 to school facility 12. A banking or other similar institution 28 is also connected to school facility 12 through the central telephone office. Connections between and among a plurality of homes 26, institution 28, school bus 14 and school facility 12 may either be direct connections via the central telephone office, may incorporate long distance connections, or may be indirectly made through an Internet service provider or providers 30 providing connectivity through a publicly accessible network 32 such as the Internet.

In accordance with the invention, it is contemplated that school facility 12 will have present numerous students 34, supervisory school personnel 36, such as teachers, and various items of property 38, such as computers, books, sports equipment, videotapes, and so forth.

Connectivity to the inventive system 10 from the school is, in accordance with a preferred embodiment of the invention, through a single computer 40. Alternatively, several computers may perform different aspects of the inventive system, such as time and attendance, dietary control and sales, activity auditing and condition detection, and inventory management, as appears more fully below.

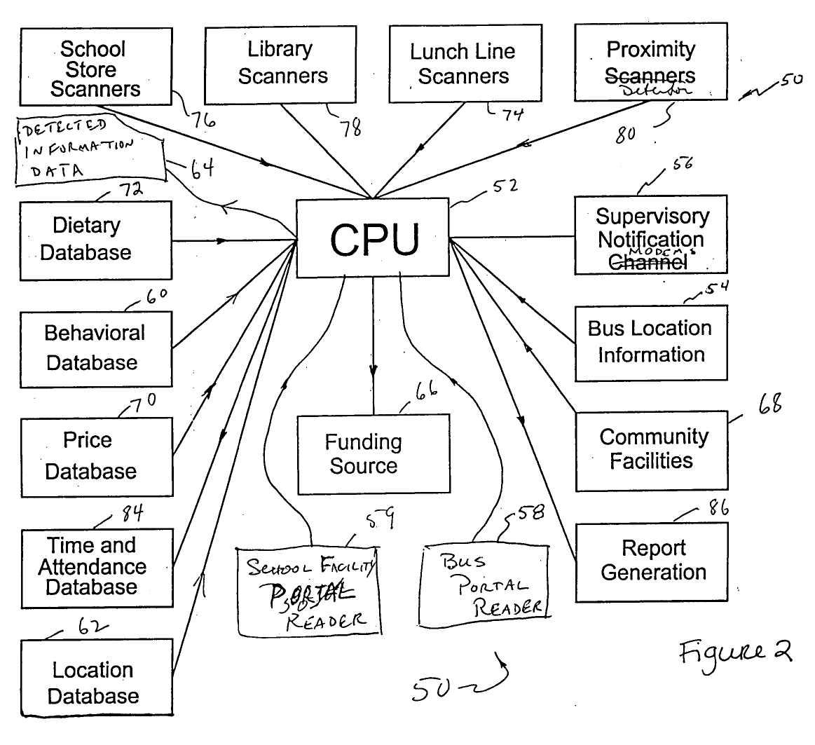

Transportation Condition Monitoring and Exposure Minimization A hardware arrangement for implementing the inventive method in conjunction with a school facility having a plurality of doors which allow the facility to be secured, cafeteria checkout lines, one or more school buses for transporting students, and existing public telecommunications facilities is illustrated in FIG. 2. In accordance with the preferred embodiment of the invention, a control circuit 50 comprises a central processing unit 52 which performs role computational, comparison, storage, reporting, financial, data collection and control functions of the system and communicates the same through appropriate interface electronic subsystems, as will be discussed in detail below.

More particularly, in accordance with the invention, buses are dispatched to pick up students at various locations within the school district. Buses are equipped with a GPS unit which, when activated, receives transmissions from the GPS network of global positioning satellites in orbit about the earth. Buses are also equipped with cellular telephone units which allow communication between buses 14 and school facility 12.

Periodically, the cellular telephone system on each bus 14 places a call to a modem 54 connected to central processing unit 52 and transmits geographic location information detected by the GPS unit on the bus. Such calls may be made once every three minutes, or periodically at a more frequent or less frequent rate. Alternatively, calls may be made at varying rates, depending upon location, general traffic conditions, expected traffic conditions, and/or other parameters which one would expect would increase the need for more or less frequent location reporting by buses 14. Another alternative is for calls to be made strictly in response to arrival at a point which is at a known short distance from a student pickup point, especially where there is a great likelihood that the bus will arrive at the pickup point in a short time with a high degree of accuracy. Still another alternative is to combine these last two alternatives according different weights to their different criteria.

An algorithm resident in central processing unit 52 periodically monitors location of buses 14 and the system and by comparing actual location to computed and/or known scenario sets of location data determines whether a condition wanting attention exists.

In addition, the bus driver may at any time use the cellular telephone system to communicate with officials at school facility 12 to provide them with any information which he judges useful and/or necessary.

When a particular bus 14 in the system reaches a geographical point which is displaced from the pickup point for a particular student by a distance in driving time equal, in expected driving time of the bus for the particular driving conditions being experienced that day, to the distance in walking time (or driving time if the student is driven by a parent or guardian to the pickup point) between the home of a student and the pickup point, the cellular telephone system on the bus initiates and places a telephone call with a recording or other speech source which tells the parent that the bus is about to arrive at the pickup point. Alternatively, this information may be sent to central processing unit 52 which, in turn, notifies the parent of the impending arrival of the bus through modem 56.

For example, if the student needs three minutes to walk to the pickup point from home, when the bus is three minutes from the pickup point in driving time, this condition is detected by the GPS system on board in the bus, and the cellular system on the bus places the automated call to the parent informing the arrival of the bus. This has the advantage of not having children waiting unattended at a bus pickup point and/or not inconveniencing parents with extended waiting time at the pickup point.

Alternatively, where desired, bus delays may be minimized by adding time to the walking time needed and giving a warning four minutes before arrival. This would make sense where there is a low likelihood of danger. Conversely, where there is a higher likelihood of danger, the telephone call could be sent two minutes before arrival and the bus would wait for the arrival of the student.

When the student boards bus 14, his presence is detected at the door of the bus by a reader 58, which detects the presence of an identification tag. This identification tag has embedded in it a code which identifies the student, and the bus portal 58 transmits the information that the identification tag of the student is proximate the reader via the cellular telephone system on board the bus. This information is received by the modem 54 and sent to the Central processing unit 52, thus confirming that the student is likely to have been safely boarded on the bus. Such systems of identification tags and readers are presently available on the market. The structure of these tags and readers forms no part of the instant invention. Such tags are small, lightweight and self powered and may be read within a range of distance. Other tags may not require power.

Reference is made to the identification data and reader system currently manufactured by Identec Solutions. Information about these systems is available at www.Identec.com.

On the return run from schools to the home, all the above systems are in place and 11 perform, as detailed above, with the exception that the pickup point is now a drop-off point and the telephone call to the home of the student, placed by modem 56, or directly to the home by the bus cellular telephone system, is met by the parent traveling alone to the bus drop-off point to take charge of the student.

Typically, the identification tags are carried by students on their persons, upon recommendation of the issuing authority. Thus, the identification tag may be in a wallet, in a vest pocket, or in a pocket sewn into a garment for that express purpose.

As buses go their routes to and from school, location information is collected by Central processing unit 52. Resident in Central processing unit 52 is information which monitors bus progress using geographic information and pickup information allowing the detection of potentially dangerous conditions. When the same are detected, Central processing unit 52 sends this information to supervisory notification modem 56, causing it to notify a responsible school employee despite being the existence in nature of potential problems and suggesting a course of action, in this case making a telephone call to the driver of the bus.

Internal Facility Module

When students arrive at the school in the bus, the portal reader on the bus detects the fact that the student has disembarked from the bus and sends this information to Central processing unit 52 via the cellular telephone connection between the bus and Central processing unit 52. After the student departs from the bus, the student then enters school facility 12 and the presence of the student is detected by a portal reader 59 at the door of the school. This reader, like the other readers in the system, is capable of detecting the presence of an identification tag carried by the student, and of reading the number embedded in the identification tag to verify the identity of the student whose presence is being detected. The activation of the portal reader at the door of the school indicates that the student has entered the school. Alternatively, a pair of portal readers 59, which are separated from each other by a distance greater than the range of a portal reader, preferably greater than twice the range of a portal reader, may be positioned to be sequentially actuated as the student enters a cordened lane on his way into school. The use of two sequential readers allows a greater degree of certainty in ascertaining the position of the student inside the facility.

In accordance with the present invention, readers are placed at various locations throughout school facility 12, for example at the doors to various classrooms, laboratories, lavatories, the gymnasium, student lounges, the cafeteria, and so forth. By monitoring student position at various times, and comparing the same to standards contained in a behavioral database 60, taken together with a location database 62, deviations from the same may be detected and the possibility of any dangerous or otherwise undesirable situation may be detected by Central processing unit 52. This information is then provided by way of modem 56 to the appropriate personnel. For example, if any student gets off the bus but fails to enter the school, the identity and description of the student may be sent via an automated message to a crossing guard or the bus driver located outside the school. The automated message can state the problem and provide information using concatonated speech, and alphanumeric pager and buzzer or other suitable notification device.

In accordance with the present invention, it is contemplated that expected locations for students at various times is listed in location database 62. The duration of time during which the student is expected to be at a particular location, and the time of such appearance at such location is stored in behavioral database 60, together with the logical sequence location for a student. Thus, if a student asks to be excused to go to the bathroom, deviations from an expected course of movement may be detected by the system. For example, the system may report to the teacher that a student has left the class, allowing the teacher to fill in the expected destination of the student, if that is desired. Alternatively, the warning may disappear after a period of time, and not come back if the student returns to class over an expected route, for example, from the classroom to the lavatory or to the principal's office. On the other hand, if the deviation occurs to an unusual location, or the path of movement is indirect, or a boy is found to have entered the women's lockers, or there is an excessive period of time spent anywhere, alarms and alphanumeric messages may be sent to teachers, the principal, or any supervisory person, or person on hand at the expected locations of the problem.

In accordance with the present invention, information respecting the location of the student and the generation of habit information for use by the algorithm in Central processing unit 52 is gathered and stored in a database of detected information 64. This information may be used to generate long-term pictures of student behavior to refine models for each student.

Similarly, if a student is found to be in a bathroom for an extended period of time, this may indicate either a medical problem or a drug problem and the teacher may be notified of the problem and corrective action, such as observation or sending the student to the authority may be suggested. In this case, the notification to the teacher may be done in a detailed alphanumeric directive displayed on a computer located in the classroom of the teacher, together with an audio alert or dramatic visual alert, if avoidance of disturbance of the class or a level of confidentiality is desired.

Cash Module

In accordance with the preferred embodiment of the invention, the inventive security system may include a cash module. The object of the inventive cash module is to integrate into the overall system or to function as a separate system and control the expenditure of student funds, prevent theft and robbery, and regulate disbursal of funds by the student.

The starting point for the cash module in accordance with the method of the present invention is a cash authorization to a funding source 66. Such cash authorization can be very well controlled by the parent or other responsible individual. For example, the arrangement may be in the form of spending limits specific to every meal in the school cafeteria, afternoon and morning snacks, and the like. In addition, the authorization by the parent may include funds to be dispersed at community facilities 68, such as a CD store, a particular bookstore of known character, or the like. Funds may be divided between funds which are generally available and funds which are available for limited periods of time, such as a single lunch hour on a particular day. The object of such general controls is to prevent, for example, a student paying for the lunch of four or five classmates in order to raise cash for, by way of example, a drug purchase.

Information respecting amounts, times, and other information for purchases made at all of these locations may be resident in a price database 70.

In addition to regulating the amount of money being spent by the student, information respecting the parental guidance with respect to diet may be contained within a dietary database 72. For example, the parent may provide cash disbursal approval only for non-dessert items, or only for certain desired items (for example milk, a fish sandwich, sparkling or still water and soup). In another case, there may simply be a ban on desserts, or on peanut products (because of allergies), thus preventing the intentional or accidental deviations from the approved foods.

More particularly, in accordance with the invention, it is contemplated that bar code scanners 74 at the end of the lunch line will scan packages of food labeled with bar codes and brought by the student to the cashier. At the same time, a reader located at the cashier of the cafeteria, effects reading of the identification code in the identification tag. This is done by reading the student identification number embedded in the tag, to verify or, and the first instance, the identification of the student. The output of scanners 74 is sent to Central processing unit 52 where algorithms resident in Central processing unit 52 use information in price database 70 and dietary database 72 to determine the appropriateness of the proposed purchase. If the same is approved by the system, Central processing unit 52 contacts in a funding source 66 and the account of the student is charged with a debit.

In similar fashion, the student may go into a neighborhood bookstore and use his account at that community facility 68. At the same time, this would input into the Central processing unit 52 information about the location of the student at a particular time. This information could be fed into the historical database collected at database 64. In accordance with the invention, it is not necessary that the neighborhood bookstore have a reader capable of reading the identity of the student.

In addition to regulating the behavior of the student with respect to the disbursal of funds, the inventive system also provides such information to school authorities to be certain that regulatory parental actions make sense.

In similar fashion, items in the school bookstore may be affixed with bar codes which are scanned by bar code readers 76, located at the cashier of the school bookstore.

Control of Loaned Materials

Central processing unit 52 may also control the record-keeping for items put out on loan to students. In accordance with the invention, library materials, such as books, videotapes, or the like, are marked with a bar code. When the student leaves the library, he displays the book to a bar code reader 78 and a portal reader 80 reads his presence using the identification tag carried on the person of the student, and the removal of the book or other material is recorded in the system as having been removed by that person. If it is not returned on time, mail may be sent to the student and/or persons responsible for the student in order to ensure compliance with the rules.

In addition, a bar code reader and proximity detector similar to bar code readers 78 and proximity detector 80 may be used in conjunction with the loan of athletic equipment, or any other materials. In the event of relatively expensive items, such as computers, the items may also receive an identification tag which may be electronically read by the portal reader.

In connection with this, it is noted that a number of identification tags may be in proximity to each other and may be read simultaneously by a particular reader. In this case, the system may be able to discern the situation. For example, if the library attendance is identified as one of the people in the proximity of the system, the system will ignore this information. In addition, the individual which the system believes to be the person buying food on a lunch line or removing a book from the library, may have his name on an alphanumerical display after his identification tag is read to be seen by both the student and the operator of the system. Additional identification may be required, such as a driver's license, and the system may display this information to the attendant operating the system.

In addition to the above, it is contemplated that the inventive system may be used to keep attendance records for students and accumulate the same in a database 84. In addition, teachers and other personnel may be required to wear identification tags and the same used as a basis for keeping time records on personnel, which information may be stored in database 84.

Further, in accordance with the present invention it is contemplated that Central processing unit 52 may output information in the form of reports that may be displayed on any suitable output device 86 such as a monitor, printer, or other human or machine interface.

In accordance the present invention, it is also contemplated that such information may be made available to parents on demand or as a “push” output, either over the Internet or through any other suitable means, such as automated telephone calls, monthly reports, or the like.

The system may further comprise a plurality of visitor identification tags, each associated with a respective school visitor and adapted to be carried by a school visitor, each identification tag incorporating a respective associated school visitor code, and wherein the algorithm resident in the computer compares known visitor staff and student locations to typical safe situation location specifications and typical unsafe situation location specifications to determine the existence of an unsafe condition.

In accordance with the invention, it is contemplated that the same will be integrated into existing point-of-sale cash register systems. It is also contemplated that a visual identification may be incorporated into the identification tag, and that such visual identification will take the form of a picture of the individual. This picture of the individual may be made identical to a picture of the individual in a database. The database image of the individual may be made available to the cashier or other person monitoring a part of the system, such as an entrance to a building, the entrance to the bus, or the like in order to confirm the identity of the individual and to maintain the security of the system.

In addition, in the event that the system is used to track and control the entry of other individuals into the school facility, such as teachers, parents, service personnel, and the like, such electronic image may be made available at the entrance to the building for verification by a human attendant.

In addition, if desired, credit lines associated with identification tags may be linked to the credit line of a parent to allow easy auditing of expenses in a single account. In addition, parents will be able to add money to the credit line of the student at any time. In connection with this, it will be appreciated that school lines will be more orderly and will more rapidly service students by increasing the amount of time available for study, teaching or the like.

Still another possible use for the inventive system is the application of the same to fund-raising. More particularly, through the use of outside businesses as sellers in connection with the inventive system, those businesses which have a stake in the operation of the school may be easily identified. In addition, the volume of business which the school creates for these businesses will also be identified. Judgements may be made with respect to the reasonable support which such a business may be asked to give to the school. Alternatively, the outside community businesses utilizing the student credit line provided by the instant invention and implementable through the use of the identification tags may be used to charge a fee to such businesses.

It will also be appreciated that information with respect to students, the speed at which a bus is traveling, the location of the bus or the student, the names of students with whom the student is associating, and the like is contained in the database of the central processing unit, and that such information may be made available to clients on demand over a publicly accessible network, such as the Internet.

Also, in accordance with the invention, those skilled in the art will understand from the specification that inventory of various equipment, supplies and materials may be tracked by the system through the use of scanners which read bar codes or identification tags associated with the equipment as it enters and leaves the school facility. The result is to produce an up-to-date record of the location of all such items and to record their consumption, if they are consumables.

Such consumables and equipment may be tagged on entry into the school facility or a combination of these techniques may be used to mark materials and equipment which one wishes to mark. In addition, doors to school freezers, dry storage or the like may have transducers linked to the central processing unit in order to provide information respecting the same.

Doors, including doors to the facility, doors to storage rooms, and the like may be automatically secured in accordance with a desired time schedule.

In accordance with a further embodiment of the invention, it is contemplated that the dedication may be used in conjunction with a password typed by an operator into the system. A higher level of security may be provided by checking the identity against biometric data, such as the weight of the individual entering. A scale for measuring the weight may be incorporated into the floor of a secure gate. Still a higher level of security may be provided by providing artificial intelligence and the input of the image of a person's face to determine the identity of the individual.

It will also be appreciated that entire classes of individuals may be scanned by including a reader in a position where all dedicated identification tags are within its range, thus taking attendance periodically during the day to ensure student attendance and saving records respecting attendance electronically.

1. A student security method for securing a school a facility with a plurality of portals to be secured, comprising the steps of:
(a) assigning a respective associated student code to each of a plurality of students;
(b) incorporating each associated student code into a respective one of a plurality of identification tags;
(c) distributing to each student an identification tag within the respective associated student code of the student receiving said identification tag;
(d) accessing sets of associated information with any a computing device, each set of associated information being associated with a respective one of said associated student codes and a respective student associated with said associated student code;
(e) using a portal reader associated with each of said plurality of portals to read a student code Inc. in an identification tag within the range of said portal reader to determine presence information;
(f) transporting students bearing said identification tags to school in a transportation vehicle having a vehicle portal;
(g) reading said student code associated with said identification tags with a vehicle reader associated with said vehicle portal to determine pickup information;
(h) downloading pickup information from said vehicle reader to said computing device;
(i) downloading presence information from said portal readers to said computing device;
(j) generating a database of student specific expected pickup and presence information;
(k) deriving behavioral and/or situational information from said presence and pickup information; and
(l) said computing device comparing said presence and pickup information to expected pickup and presence information to determine deviations from expected behavioral and/or situational standards.

2. A method as in claim 1, wherein said portal reader and said vehicle reader read said student code incorporated in said tags while said tags are not visible.

3. A method as in claim 1, further comprising distributing a plurality of staff identification tags, each staff identification tag being associated with a respective school staff member and being carried by a school staff member, storing a respective associated school staff member code in each staff identification tag, and generating school staff time records with said computing device.

4. A method as in claim 1, wherein said algorithm generates school student attendance records.

5. A method as in claim 1, further comprising a plurality of lend items, each of said lend items comprising a lend item identification tag incorporating a respective associated lend item code identifying its respective lend item, wherein said portal reader associated with said portal is capable of reading said lend item codes associated with said lend item identification tags to determine lend item presence information to generate a proposed lend description comprising a lend item identity or lend item identities, an algorithm being resident in said computing device, said algorithm structured to compare said lend item identity(s), a student code within the range of said reader, and a list of approved lend item information and derive a signal indicating a decision of approval or disapproval with respect to removal of said lend item across said portal.

6. A student activity and condition monitoring system for students in a school, comprising:
(a) a plurality of identification tags, each associated with a respective student and adapted to be carried by a student, each identification tag incorporating a respective associated student code;
(b) a database of student specific sets of associated parental supervision information, each of said sets of associated parental supervision information associated with a respective one of said associated student codes and being particular to the respective associated student;
(c) a computing device having access to said sets of associated parental supervision information;
(d) a point of sale device, comprising:
(i) a device for inputting product identities for products to be purchased by a particular student to generate a proposed purchase description comprising a particular set comprising a product identity or a plurality of product identities;
(ii) a point of sale reader capable of reading said student code associated with said identification tags to generate a particular student code associated with said particular student; and
(iii) a communications link between said point of sale device and said computing device;
(e) an algorithm resident in said computing device, said algorithm structured to compare said particular product identities and a set of parental supervision information associated with said particular student code and derive a signal indicating a decision of approval or disapproval with respect to said proposed purchase description; and
(f) a telecommunications channel between said computing device and a source of funds.

7. A method as in claim 6 wherein said products comprise a bar code imprint and said device for inputting product identities for products to be purchased by a particular student to generate a proposed purchase description comprising a particular set comprising a product identity or a plurality of product identities is a bar code reader.

8. A student security system for securing the safe transport of students to school, where said students are under the care of custodial individuals, comprising:
(a) a plurality of identification tags, each associated with a respective student and adapted to be carried by a student, each identification tag incorporating a respective associated student code;
(b) a computing device having access to sets of associated pickup information, each set associated with a respective one of said associated student codes, said associated information being particular to the respective associated student;
(c) a transportation vehicle having a vehicle portal;
(d) a geographic position sensing system associated with said transportation vehicle 11 for generating a geographic information signal;
(e) a vehicle reader associated with said vehicle portal, said vehicle reader being capable of reading said student code associated with said identification tags to determine pickup information;
(f) a communications link between said geographic position sensing system and said computing device sending said geographic information signal to said computing device;
(g) a database of student specific expected pickup locations;
(h) an algorithm resident in said computing device for deriving geographical proximity to a pickup location for a respective student from said geographic position sensing system, and comparing said geographic information signal to a respective expected pickup location to determine an expected pickup time; and
(i) a telecommunications channel between said computing device and said custodial individuals for reporting pickup information to said custodial individuals.

9. A system as in claim 8, wherein said geographic information signal is sent at varying rates, depending upon location, general traffic conditions, expected traffic conditions, and/or other parameters which one would expect would increase the need for more or less frequent location reporting.

10. A system as in claim 8, wherein said geographic position sensing system associated with said transportation vehicle is a satellite based positioning system.

11. A system as in claim 8, wherein said database of student specific expected pickup locations further comprises information indicating the time needed to transport said student to a respective associated pickup location, and wherein said algorithm causes said computing device to transmit along said telecommunications channel to said custodial individuals expected pickup information.

12. A system as in claim 11 wherein said telecommunications channel is the public telephone system.

13. A system as in claim 11, wherein said telecommunications channel is a publicly accessible computer network.

14. System as in claim 8 wherein said telecommunications channel is the public telephone system, and said telecommunications channel is a publicly accessible computer network, further comprising:
(a) a plurality of identification tags, each associated with a respective student and adapted to be carried by a student, each identification tag incorporating a respective associated student code;
(b) a database of student specific sets of associated parental supervision information, each of said sets of associated parental supervision information associated with a respective one of said associated student codes and being particular to the respective associated student;
(c) a computing device having access to said sets of associated parental supervision information;
(d) a point of sale device, comprising:
(i) a device for inputting product identities for products to be purchased by a particular student to generate a proposed purchase description comprising a particular set comprising a product identity or a plurality of product identities;
(ii) a point of sale reader capable of reading said student code associated with said identification tags to generate a particular student code associated with said particular student; and
(iii) a communications link between said point of sale device and said computing device;
(e) an algorithm resident in said computing device, said algorithm structured to compare said particular product identities and a set of parental supervision information associated with said particular student code and derive a signal indicating a decision of approval or disapproval with respect to said proposed purchase description; and
(f) a telecommunications channel between said computing device and a source of funds.

15. A system as in claim 14, wherein said products comprise a bar code imprint and said device for inputting product identities for products to be purchased by a particular student to generate a proposed purchase description comprising a particular set comprising a product identity or a plurality of product identities is a bar code reader.

16. A system as in claim 14, further comprising a facility with a plurality of portals to be secured.

17. A system as in claim 16, wherein said portal reader and said vehicle reader are capable of reading said student code incorporated in said tags while said tags are not visible.

18. A system as in claim 17, further comprising area readers capable of reading the presence of tags within their range, and wherein said algorithm compares known student locations to typical safe situation location specifications and typical unsafe situation location specifications to determine the existence of an unsafe condition.

19. A system as in claim 16, further comprising a plurality of visitor identification tags, each associated with a respective school visitor and adapted to be carried by a school visitor, each identification tag incorporating a respective associated school visitor code, and wherein said algorithm compares known visitor staff and student locations to typical safe situation location specifications and typical unsafe situation location specifications to determine the existence of an unsafe condition.
